(19) United States
(12) Patent Application Publication
(10) Pub. No.: US 2026/0221795 A1
(43) Pub. Date: Jul. 30, 2026

(54) METHOD AND DEVICE FOR TRICKLE CHARGING A BATTERY OF A VEHICLE

(71) Applicant: MERCEDES-BENZ GROUP AG, Stuttgart (DE)

(72) Inventor: Karsten FUNK, Stuttgart (DE)

(21) Appl. No.: 19/141,679

(22) PCT Filed: Dec. 7, 2023
(86) PCT No.: PCT/EP2023/084659

§ 371 Date: Jun. 20, 2025

(30) Foreign Application Priority Data
Dec. 21, 2022 (DE) 10 2022 004 834.5

(51) Int. Cl. H02J 7/90; H02J 7/34; H02J 7/35; H02J 7/44; H02J 7/96; H02J 105/33

(52) U.S. Cl. CPC H02J 7/927; H02J 7/345; H02J 7/35; H02J 7/44; H02J 7/933; H02J 7/96; H02J 2105/33; H02J 2207/50

(57) ABSTRACT

A vehicle battery is trickle charged using current pulses of an energy source having a specifiable time duration and provided to the battery in a specifiable interval of time until a voltage of the battery is at least equal to a voltage of the energy source. In this case, the time duration of the current pulses and the interval of time between the current pulses are selected such that an onboard power supply of the vehicle remains in a passive mode.

### BACKGROUND AND SUMMARY OF THE INVENTION

Exemplary embodiments of the invention relate to a method and a device for trickle charging a battery of a vehicle.

Vehicle batteries, in particular starter batteries, are liable to natural self-discharge because of the cell chemistry. If vehicles are not moved for a relatively long time, this self-discharge can progress so much that the vehicle can no longer be started. It is therefore customary to charge the battery either shortly before restarting with normal charging current or continuously with a significantly lower current over the time the vehicle is parked. In the latter case, this is known as battery trickle charging.

EP 3 459 155 B 1 describes a method for charging a battery. The method comprises selecting a pulse period. In this case, a charging pulse is provided to the battery. For this, a charging current is provided from a power source to the battery at the beginning of an ON period of the charging pulse. A current flow through the battery is determined and a change in the current flow though the battery is detected. A duration of the ON period of the charging pulse is determined, based on when the change of the current flow through the battery was detected relative to applying the charging current to the battery. The charging current from the power source to the battery is interrupted at an end of the ON period of the charging pulse. Thereafter, a duration of an OFF period of the charging pulse is determined. In this case, a difference between the selected pulse period and the ON period of the charging pulse is computed. There is a delay for a duration of the OFF period of the charging pulse. A further pulse period is then selected. These steps are repeated using the selected pulse period.

U.S. Pat. No. 4,661,758 discloses a solar power supply and a battery charging system with a solar energy source that supplies consumption current to a load and charging current to a secondary battery when the solar source is exposed to sunlight. A secondary battery is series connected to the solar energy source and is charged by the current supplied by the solar energy source. A control circuit is connected to the battery to determine the state of charge of the battery and in turn controls the operation of a generator with a variable pulse width. The output pulses of the pulse width generator are applied to a short-circuit shunt switch, which is connected to the terminals of the connected energy source, in order to open the short-circuit switch periodically for different time intervals that are determined by the state of charge of the secondary battery.

In solar controllers, two methods are primarily used for feeding power into electrical energy storage devices: what is known as pulse width modulation (PWM) and what is known as maximum power point tracking (MPPT).

In pulse-width modulation a square wave signal is set to oscillate between two different voltage levels. In this case, in particular, one voltage level can also be zero, so that in principle a signal is also possible as a rapid sequence of a switched-on and switched-off state. Pulse-width modulations have many uses in electronics.

The term maximum power point tracking is used in electrical engineering, in particular in photovoltaics, to refer to a method in which the electrical loading of a solar cell, a solar module, or several solar modules connected in series is adapted such that the largest possible amount of power can be drawn from the cells. In solar cells, this optimal operating point is not constant, but depends on, inter alia, the irradiation intensity, the temperature at the solar module, and the type of solar cells.

Exemplary embodiments of the invention are directed to an improved method for trickle charging a battery of a vehicle, as well as to a device for trickle charging a battery of a vehicle with such an improved method.

Expedient configurations and advantages of the method become apparent from the description and the drawing.

According to one aspect of the method, a method for trickle charging a battery of a vehicle is proposed, wherein current pulses of an energy source with a specifiable time duration are provided to the battery in a specifiable interval of time until a voltage of the battery is at least equal to a voltage of the energy source. In this case, the time duration of the current pulses and the interval of time between the current pulses are selected such that an onboard power supply of the vehicle remains in a passive mode.

The onboard power supply of a modern motor vehicle always has a low quiescent current that causes the battery to discharge. Advantageously, therefore, an improved charging method for trickle charging the battery is proposed, which can charge the battery with less power, for example by a solar module, without an active onboard power supply of the vehicle being able to consume more power than the solar module can supply.

In order to be able to charge the battery continuously with low power to maintain the state of charge, an undesired activation of the onboard power supply, which would occur with a continual charging current, can be avoided. It is therefore proposed to only deliver the charging current to the battery in pulsed fashion. The current pulse is selected to be so short that the electronic system of the onboard power supply is not activated and remains in a passive mode or rest mode, wherein the next current pulse only occurs again after a certain duration, which allows the system to stay in sleep mode. The current pulses are selected to be so short and occur at such a large interval of time that any available fault suppression of the onboard power supply suppresses these current pulses as not being relevant and the vehicle or the electrical consumers thereof are not activated or “woken up”.

The pulsation can be set advantageously depending on the respective onboard electronics used in the vehicle. The pulse length can be selected accordingly to be short enough and the charging current can be selected accordingly to be small enough that these values are accepted in the fluctuation range of faults in the onboard power supply. This means that undesired activation of the onboard power supply, which would activate or wake up control devices, can be prevented. The control devices would then be active for a certain duration and would consume current, which can be prevented according to the invention. It is possible to wait a sufficient amount of time before the next current pulse until the onboard power supply has forgotten the fault again and then recognizes the charging current as a new, tolerable fault during the next current pulse, this new fault staying below an upper fault limit that would otherwise lead to the onboard power supply waking up.

The current pulses can be applied to the battery in a periodic sequence with a certain periodic interval of time. However, this is not absolutely necessary. Optionally, the current pulses can also be applied in an irregular sequence. The interval of time between the current pulses can correspond to a minimum time interval or be greater than the minimum time interval.

In accordance with one advantageous design, the method can comprise at least the steps of: determining the voltages of the battery and of the energy source by means of a control unit, wherein the control unit is electrically coupled to the energy source and the battery; if the voltage of the battery is less than the voltage of the energy source, checking whether a control pulse, in particular of a pulse generator, has been applied to the control unit; if the control pulse has been applied, switching through a switching element by means of the control unit, this switching through providing the current pulse to the battery; checking whether the control pulse is switched off; if the control pulse is switched off, blocking the switching element.

In this way, the battery can be recharged with a limited amount of power without the onboard power supply being activated. A prerequisite for this is that the energy source supplies a voltage that exceeds the voltage of the battery. The sequence of current pulses can advantageously be controlled via a pulse generator that specifies for the control unit the suitable time duration and the interval of time with which the current pulses are to be provided to the battery. The control unit can then provide the battery with the thus defined current pulses by triggering a suitable switching element.

In accordance with one advantageous design of the method, the time duration of the current pulses and the interval of time between the current pulses can be set manually according to specifiable parameters and/or determined from a characteristic map of the vehicle and/or ascertained by measurements on the battery and/or the energy source. The specifiable parameters can be determined, in particular, by the actual onboard power supply. The entire system for trickle charging can be adjusted advantageously to different vehicle systems. The required values can be set manually according to parameters, read from a characteristic map for the respective vehicle or determined by testing and measuring, so that the parameters of the charging electronics can be suitably set for the current pulses, in particular length, magnitude of the current pulses, and time intervals between the current pulses.

In accordance with one advantageous design of the method, a solar module can be used as energy source, wherein electrical energy produced by the solar module is buffer-stored in an electrical buffer store.

The use of a solar module as an energy source makes possible autonomous battery trickle charging based on a comparatively small solar panel. Such a solar module proves to be sufficient even in unfavorable weather conditions in the winter. Moreover, such a solar module can be realized particularly simply and cost-effectively.

Upon solar irradiation, the solar module generates electrical energy that is supplied to the buffer store. The buffer store can be designed as a capacitor, for example. As soon as the voltage of the buffer store has reached a value that is significantly above the battery voltage, a current pulse can be provided to the battery.

Advantageously, the buffer store can be of such a size that the method according to the invention is able to be carried out with very little technical outlay. If the buffer store is designed as a capacitor, in particular as a supercapacitor known as supercap or multiple interconnected capacitors, which then, for example, have a capacitance of over one farad, in particular of over 10 farad, enough power can then be buffer-stored to provide a corresponding charging pulse for trickle charging the battery. Thus, for example, an electrical energy of at least 1000 joules can be stored in such a buffer store, so that a charging pulse with 100 joules of electrical energy can be delivered to the battery without emptying the buffer store by the same amount.

Such a design of the buffer store would make it particularly advantageously possible to make it easier to control the charging pulses, since the voltage of the capacitor changes due to the electrical energy stored in the capacitor and thus the charging pulse can start as soon as the voltage in the capacitor rises above a first value, and then continues to fall due to the capacitor discharging with the charging pulse of the battery until the voltage of the capacitor substantially corresponds to the battery voltage, which causes the current flow to decrease due to the falling voltage difference between the capacitor and the battery and come to a halt. Advantageously, the charging pulse can also be ended if the voltage at the capacitor falls below a second value, since due to the smaller voltage difference between the capacitor and the battery it would then be barely possible to efficiently trickle charge the battery. However, at the latest after a maximum duration of the charging pulse, this is ended anyway in order to be able to comply with the specification of leaving the onboard power supply of the vehicle in the passive mode.

In order to realize the method according to the invention, the temporal sequence and duration of the charging pulse still need to be controlled, implemented, and adhered to, meaning that a simple clock generator or pulse generator can also be used for this purpose, for example.

Advantageously, the method according to the invention can be realized using a correspondingly large capacitor as a buffer store, by, in particular, determining the voltage at the capacitor and determining the charging pulses by the duration and temporal sequence thereof. Accordingly, a charging pulse from the buffer store is started at the battery when the voltage at the capacitor is above a first value and a minimum duration has elapsed since the end of the last charging pulse. Depending on the design of the components, the duration of the charging pulse per se can then also be determined by a pulse generator in order to end charging pulses that are too long if the capacitance of the buffer store is so large that otherwise it would take too long for it to discharge for trickle charging the battery in order to leave the onboard power supply of the vehicle in a passive mode.

Particularly advantageously in this case, the first value of the voltage of the capacitor, above which the charging pulse can start, can be specified for the system and/or can be set in the system. Here too, in particular the time duration between the charging pulses, above all between the end of a previous charging pulse and the beginning of a current charging pulse, can be specified for the system, in particular a pulse generator, and/or set.

If the system operates with a maximum duration of the charging pulse, which can then naturally also be specified and/or set, the time duration can also be used directly between the starting of consecutive charging pulses, since the maximum duration of the charging pulses and the time duration between the charging pulses can be added up here.

In order to comply with the specification of leaving the onboard power supply of the vehicle in a passive mode and this condition closely depends on the parameters of the onboard power supply and the activation thereof, these parameters also have to be taken into account for the value of the voltage of the buffer store and the time duration, so that these always have to be adapted to the respective onboard power supply and therefore at least to the respective vehicle type. These values and parameters are to be specified for this purpose and can, for example, be input directly, preset by the manufacturer and/or selected from stored values. It is possible to determine these values at the beginning by means of a test measurement of the system for trickle charging in the onboard power supply itself and then save the ascertained values for implementation.

Predefined and stored values can also be set, for example, using the vehicle data, be determined from a characteristic map or also by communication between the system for trickle charging and the onboard power supply itself.

Due to this advantageous design it is possible to construct a particularly simple system and to use it to enable a battery to be trickle charged. In addition, such a system can always supply itself with energy by the buffer store for control purposes, so that no external energy is needed control purposes. If the buffer store is completely emptied, no charging pulses need to be controlled and if the buffer store is full again, the initial energy of the buffer store can be used for the control, in particular to operate the pulse generator and to determine the voltage at the buffer store itself. A corresponding charging pulse is only output anyway if the voltage is above a first value, meaning that there is always enough energy in the buffer store to operate the control system in advance.

In addition, this design enables a fully autonomous control and arrangement of the system for trickle charging at or in the vehicle and thus also avoids any influence on the onboard power supply, since the essential specification of leaving the onboard power supply of the vehicle in a passive mode is always complied with and thus has no effect on it. Apart from the charging pulses for trickle charging, the battery of the vehicle also stays technically completely unaffected and no other adjustments are needed.

In accordance with one advantageous design, the method can further comprise:
determining the voltage of the buffer store by means of the control unit, wherein the control unit is electrically coupled to the buffer store and the battery; if the voltage of the buffer store is greater than the voltage of the battery, checking whether it is possible or permissible to provide the current pulse; if it is possible or permissible to provide the current pulse, switching through the switching element by means of the control unit, this switching through providing the current pulse to the battery; checking whether an end of the time duration of the current pulse has been reached; if the end of the time duration of the current pulse has been reached, blocking the switching element.

In this way, the battery can be recharged with a limited amount of power without the onboard power supply being activated. A prerequisite for this is that the voltage of the buffer store significantly exceeds the voltage of the battery significantly. The control unit then checks whether a sufficiently long time has elapsed since the last current pulse, so that a new current pulse can be provided. The control unit can then provide the next current pulse to the battery by triggering the switching element. It is then checked if the end of the time duration of the current pulses has been reached. If the end has been reached, the switching element is blocked and the current pulse is switched off. The control unit can then revert to determining the voltage of the buffer store. By a suitable design of the solar module in relation to the size of the buffer store, an advantageous trickle charging can thus be achieved.

According to a further aspect of the invention, a device for trickle charging a battery of a vehicle using such a method is proposed, at least comprising an energy source that is electrically coupled to the battery via a control unit during normal operation. In this case, the control unit is designed for providing current pulses from the energy source with a specifiable time duration in a specifiable interval of time to the battery.

Advantageously, is a device for the improved charging method for trickle charging the battery is proposed, which can charge the battery with low power, for example by a solar module, without an active onboard power supply of the vehicle being able to consume more power than the solar module supply.

In order to be able to charge the battery continuously with low power to maintain the state of charge, an undesired activation of the onboard power supply, which would occur with a continual charging current, can be avoided. It is therefore proposed to only deliver the charging current to the battery in pulsed fashion. The current pulse is selected to be so short that the electronic system of the onboard power supply is not activated and remains in a passive mode or sleep mode, wherein the next current pulse only occurs again after a certain duration, which allows the system to stay in the sleep mode. In this case, the current pulses are selected to be so short and occur at such a large interval of time that any available fault suppression of the onboard power supply suppresses these current pulses as not being relevant and the vehicle or the electrical consumers thereof are not activated or “woken up”.

The pulsation can be set advantageously depending on the respective onboard electronics used in the vehicle. The pulse length can be selected accordingly to be short enough and the charging current can be selected accordingly to be small enough that these values are accepted in the fluctuation range of faults in the onboard power supply. This means that undesired activation of the onboard power supply, which would activate or wake up control devices, can be prevented. The control devices would then be active for a certain duration and would consume current, which can be prevented according to the invention. It is possible to wait a sufficient amount of time before the next current pulse until the onboard power supply has forgotten the fault again and then recognizes the charging current as a new, tolerable fault during the next current pulse, this new fault staying below an upper fault limit that would otherwise lead to the onboard power supply waking up.

The device can be installed directly in a vehicle or also added to a vehicle as a retrofit system. Such a device as retrofit system can also be installed and used permanently or only temporarily due to the minimal intervention in the vehicle system. Thus, for example, such a device can also be installed only for a relatively long period of inactivity, when parked or for a waiting period outside, and also be removed again if the vehicle is in continuous operation and trickle charging is not needed.

In accordance with one advantageous design of the device, the control unit can comprise a pulse generator or be electrically coupled to a pulse generator. The pulse generator controls the sequence and duration of the individual current pulses. The pulse generator can be connected to the control unit as a separate unit. Alternatively, however, it is also possible that the pulse generator is integrated in the control unit.

In accordance with one advantageous design of the device, the energy source can be designed as a solar module with an electrical buffer store. This buffer store can be designed for buffer-storing electrical energy of the solar module produced in the solar module produced.

The use of a solar module as energy source enables autonomous battery trickle charging on the basis of a comparatively small solar panel. Such a solar module proves to be sufficient even in unfavorable weather conditions in the winter. Moreover, such a solar module is particularly simple and cost-effective to realize and replace if damaged.

Upon solar irradiation, the solar module generates electrical energy that is supplied to the buffer store. The buffer store can be designed as a capacitor, for example. As soon as the voltage of the buffer store has reached a value that is significantly above the battery voltage, a current pulse can be provided to the battery.

Advantageously, the proposed device can thus supply itself with energy. The control unit as a solar controller can feed itself energy from the solar module. The means that the moment the first ray of sun arrives, the buffer store, for example a capacitor, begins to fill up and the capacitor therefore charges. That is independent of whether the solar module is being used for the very first time or only for driving out of an underground car park after being parked for a relatively long time.

As soon as a voltage is reached at the capacitor that is sufficient to operate the processor of the control unit, the control unit can start the process. Since the capacitor during recharging only discharges to no more than the voltage of the battery and this is significantly above the requisite operating voltage of the processor, the solar module remains in operation for as long as there is enough sunlight to compensate for the self-discharge due to the self-consumption of the control electronics via the solar energy that continues to be supplied.

In accordance with one advantageous design of the device, the control unit can be designed for providing the current pulses to the battery by triggering a switching element. In particular, the switching element can be designed as a semiconductor switching element, in particular as a transistor. In particular, the switching element can be designed for switching a negative electrical potential. The sequence of current pulses can be controlled via a pulse generator, which specifies for the control unit the suitable time duration and the interval of time at which the current pulses are to be provided to the battery. The control unit can then advantageously provide the thus defined current pulses to the battery by triggering a suitable switching element.

Advantageously, the solar module can be electrically coupled to the buffer store via an electrical diode in a forward direction. The diode prevents a reverse discharge of the buffer store when the solar radiation wanes. Furthermore, the buffer store can be electrically coupled to the vehicle via an electrical diode connected in the forward direction. This diode ensures that the battery does not reverse charge the buffer store if there is a fault.

Advantageously, the energy source, in particular the solar module, can also be electrically coupled to the battery via an electrical resistor in order to limit the recharging current due to voltage difference between buffer store and battery when opening the switching element.

In accordance with one advantageous design of the device, the energy source can be electrically coupled to the vehicle via at least one electrical fuse. The fuse ensures that the energy source is safely separated from the vehicle in the event of a fault.

In accordance with one advantageous design of the device, the energy source can be electrically coupled to the vehicle via a jump start cable support point. As a result, the device can be connected to the vehicle electrically in a particularly favorable way. Such a jump start cable support point is very common in vehicles. It can ensure a continuous connection to battery of the vehicle. In this way, the charging current only flows parallel to and not series with the other systems of the onboard power supply of the vehicle. In addition there is no need to intervene in the electrical wiring of the battery, which is advantageous for safety reasons, in particular for a retrofit system.

Further advantages result from following description of the drawings. The drawings depict an exemplary embodiment of the method. The drawings, the description and the claims contain numerous features in combination. The person skilled in the art will also expediently consider the features individually and combine them to form further meaningful combinations.

### BRIEF DESCRIPTION OF THE DRAWING FIGURES

The figures show:

FIG. 1 a system overview of a device for trickle charging a battery of a vehicle according to an exemplary embodiment of the invention;

FIG. 2 a flowchart of a method for trickle charging a battery of a vehicle with a device according to FIG. 1;

FIG. 3 a temporal sequence of current pulses for trickle charging a battery of a vehicle according to one exemplary embodiment of the invention;

FIG. 4 a system overview of a device for trickle charging a battery of a vehicle according to a further exemplary embodiment of the invention; and

FIG. 5 a flowchart of a method for trickle charging a battery of a vehicle with a device according to FIG. 4.

In the Figures, identical components of those of identical type are given the same reference numbers. The Figures merely show examples and are not to be understood as restrictive.

### DETAILED DESCRIPTION

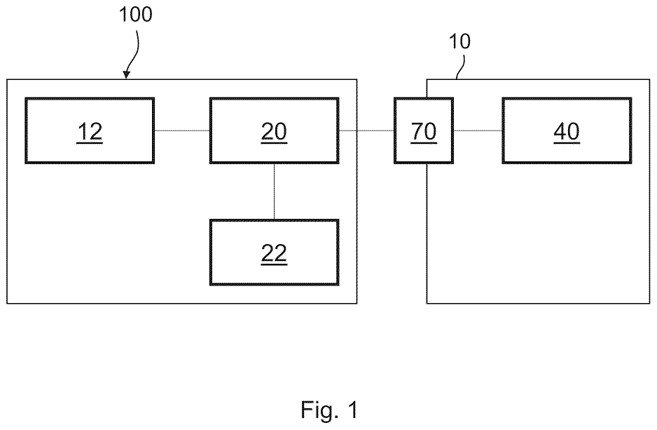

FIG. 1 shows a system overview of a device 100 for trickle charging a battery 40 of a vehicle 10 according to one exemplary embodiment of the invention.

The device 100 comprises an energy source 12, which is electrically coupled to the battery 40 of the vehicle 10 via a control unit 20 during normal operation. The device 100 is electrically coupled to the vehicle 10 via a jump start cable support point 70.

The control unit 20 is designed for providing the battery 40 with current pulses 50 from the energy source 12 with a specifiable time duration 52 in a specifiable interval of time 54. For this, the control unit 20, as illustrated in FIG. 1, can be electrically coupled to a pulse generator 22, which provides the temporal basis for providing the current pulses 50. Alternatively, the pulse generator 22 can also be integrated in the control unit 20.

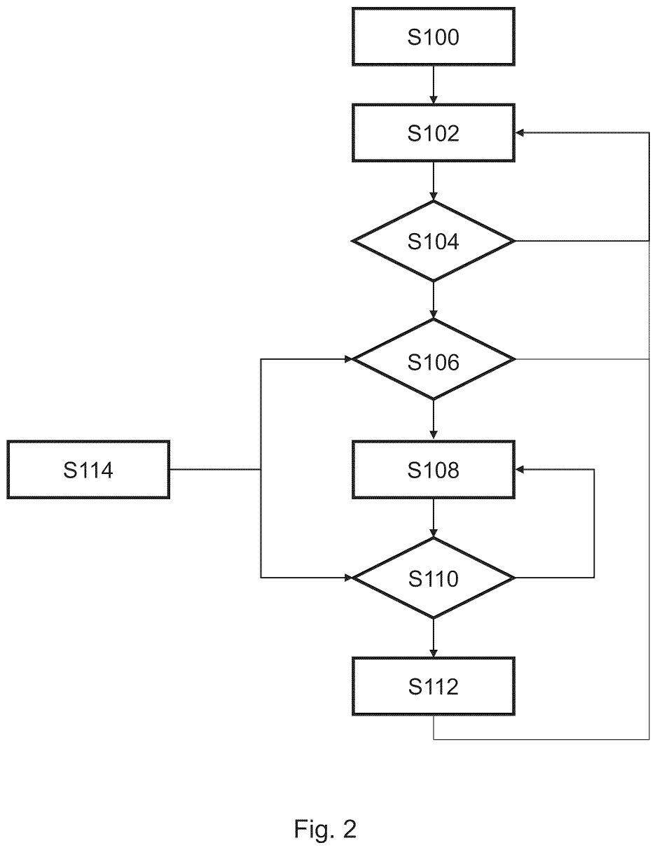

FIG. 2 shows a flowchart of a method for trickle charging the battery 40 of the vehicle 10 with the device 100 according to FIG. 1.

In accordance with the method, current pulses 50 from an energy source 12 with a specifiable time duration 52 are provided to the battery 40 in a specifiable interval of time 54, until a voltage of the battery 40 is at least equal to a voltage of the energy source 12. In this case, the time duration 52 of the current pulse 50 and the interval of time 54 between the current pulses 50 is selected such that an onboard power supply of the vehicle 10 remains in a passive mode.

It has been empirically established that current pulses of, for example, 4 seconds in length and with a pause of at least 15 seconds, are ignored by the onboard power supply of a vehicle 10.

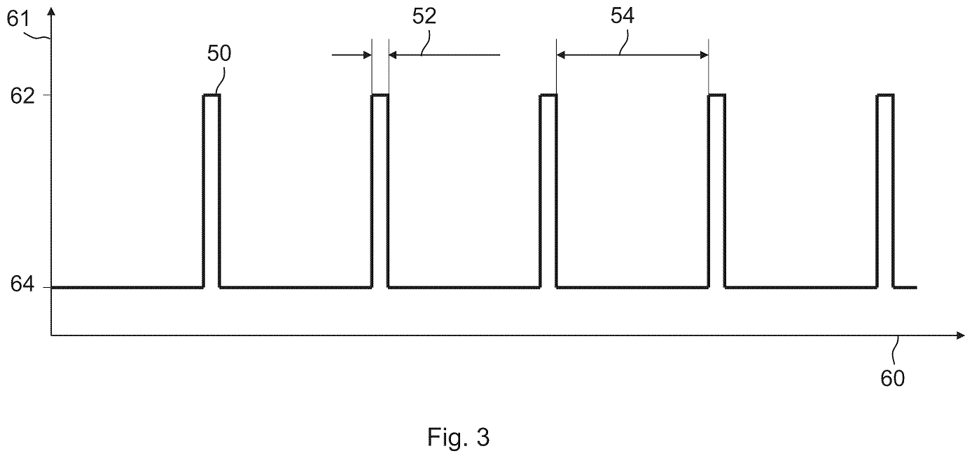

Such a temporal sequence of current pulses 50 is shown by way of example in FIG. 3. The current 61 varies in this case as a function of the time 60 between an Off state 64 and a On state 62. The current pulses 50 have a time duration 52 and are provided with a minimum time interval 54. Optionally, a longer time interval 54 can be selected.

The method comprises at least the steps shown in FIG. 2. The process starts in step S100. Then, in step S102, the voltages of the battery 40 and of the energy source 12 are determined by means of the control unit 20.

In the next step S104 it is checked whether the voltage of the battery 40 is less than the voltage of the energy source 12. If this is not the case, the voltage determination is repeated in step S102.

This loop is performed until the voltage of the battery 40 is less than the voltage of the energy source 12.

Thereafter, it is checked in step S106 whether a control pulse of a pulse generator 22, which is generated in step S114, has been applied to the control unit 20. If this is not the case, the voltage determination is repeated in step S102.

If the control pulse has been applied, a switching element 24, for example a switch or a transistor, is switched though by the control unit 20 in step S108, which provides the current pulse 50 to the battery 40.

Next, in step S110 it is checked whether the control pulse has been switched off again. If this is not the case, the process jumps back to step S108. This is repeated until the control pulse is switched off.

If the control pulse has been switched off, the switching element 24 is blocked in step S112, thereby ending the current pulse 50. Thereafter, the loop starts anew with step S102.

The time duration 52 of the current pulse 50 and the interval of time 54 between the current pulses 50 can be set manually according to specifiable parameters. Alternatively or additionally, the values can be determined from a characteristic map of the vehicle 10. It is also possible for the values to be ascertained by measurements on the battery 40 and/or the energy source 12.

In this way, the battery 40 can be recharged with a limited amount of power without the onboard power supply being activated. A prerequisite for this is that the energy source 12 supplies a voltage that exceeds the voltage of the battery 40. The sequence of current pulses 50 can advantageously be controlled via a pulse generator 22, which specifies for the control unit 20 the suitable time duration and the interval of time at which the current pulses 50 are to be provided to the battery 40. The control unit 20 can then provide the battery 40 with the thus defined current pulses 50 by triggering a suitable switching element 24.

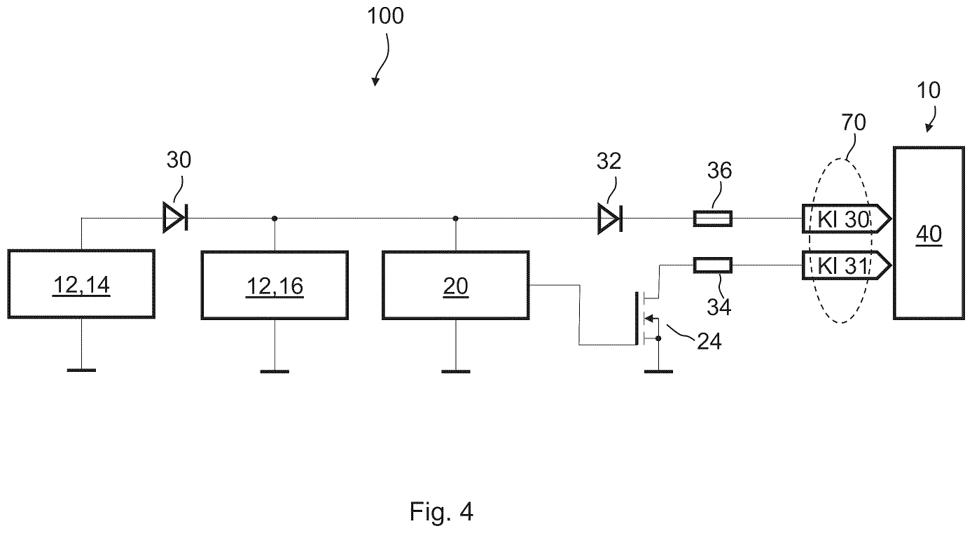

FIG. 4 shows a system overview of a device 100 for trickle charging a battery 40 of a vehicle 10 according to a further exemplary embodiment of the invention.

Here, the energy source 12 is designed as a solar module 14 with an electrical buffer store 16, wherein the buffer store 16 is used for buffer-storing electrical energy of the solar module 14 produced in the solar module 14. The buffer store 16 can be designed as a capacitor, for example.

The device 100 is electrically coupled to the battery 40 via the terminal 30, which represents the positive electrical potential of the battery 40, and via the terminal 31, which represents the negative electrical potential and/or the electrical vehicle mass of the battery 40. Terminal 30 and terminal 31 can, for example, be connected via the jump start cable support point 70 of the vehicle 10.

The control unit 20 can switch the current pulses 50 to the battery 40 by triggering a switching element 24, for example a transistor or another suitable semiconductor switching element, via the negative electrical potential. The control unit 20 comprises in this exemplary embodiment the pulse generator 22, which can be designed simply as a threshold value generator.

The solar module 14 is electrically coupled to the buffer store 16 via a forward-connected electrical diode 30. The diode 30 prevents reverse discharging of the buffer store 16 when the solar radiation wanes.

The energy source 12 is electrically coupled to the vehicle 10 via a forward-connected electrical diode 32. This diode 32 ensures that in the event of a fault the battery 40 does not reverse charge the buffer store 16.

The energy source 12 is electrically coupled to the battery 40 via an electrical resistor 34, in order to limit the recharging current due to the voltage difference between buffer store 16 and battery 40 when opening the switching element 24.

The energy source 12 is electrically coupled to the vehicle 10 via at least one electrical fuse 36. The fuse 36 ensures that the energy source 12 is safely separated from the vehicle 10 in the event of a fault.

Upon solar irradiation, the solar module 14 generates electrical energy which is supplied to the buffer store 16. The buffer store 16 can be designed, for example, as a capacitor. As soon as the voltage of the buffer store 16 has reached a value that is significantly above the battery voltage, a current pulse 50 can be provided to the battery 40.

Advantageously, the proposed device 100 supplies itself with energy. The control unit 20 as a solar controller feeds itself energy from the solar module 14. This means the moment the first ray of sun arrives, the buffer store 16, for example a capacitor, begins to fill up and the capacitor therefore charges. This is independent of whether the solar module 14 is being used for the very first time or only for driving out of an underground car park after being parked for a relatively long time.

As soon as a voltage is reached at the capacitor that is sufficient to operate the processor of the control unit 20, the control unit 20 starts the process. Since the capacitor during recharging only discharges to no more than the voltage of the battery 40 and this is significantly above the requisite operating voltage of the processor, the solar module 14 remains in operation for as long as there is enough sunlight to compensate for self-discharge due to the self-consumption of the control unit 20 via the solar energy that continues to be supplied.

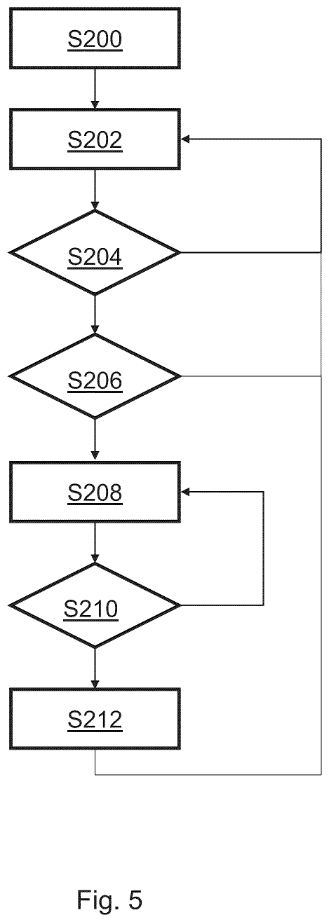

FIG. 5 shows a flowchart of the method for trickle charging the battery 40 of the vehicle 10 with the device 100 according to FIG. 4.

After the initialization, i.e., after the reaching the processor operating voltage in step S200, the control unit 20 in step S202 starts to measure the voltage of the buffer store 16, which is proportional to the state of charge of the buffer store 16, for example a capacitor, and is thus a measure of the storage content of the buffer store 16.

If this state of charge is high enough, i.e., the capacitor voltage is for example 2 V above the battery voltage, which is checked in step S204, the algorithm checks in step S 206 whether a current pulse 50 was already provided shortly beforehand. Therefore, the necessary charging pause, the minimum time interval 54 of the current pulses 50, is checked, so that the onboard power supply of the vehicle 10 is not woken up.

If the charging pause has already elapsed, for example when what is known as a charge enable flag has been set, the switching element 24 switches through in step S 208 and the buffer store 16 discharges itself into the battery 40. A corresponding current pulse 50 is provided to the battery 40.

During this process, it is checked in step S210 whether the end of the charging pulse duration, i.e., an end of the time duration 52 of the current pulse 50, has already been reached. If not, the switching element 24 stays open.

If the end of the charging pulse duration has been reached, the switching element 24 is switched off in step S212 and the algorithm goes back to the range for measuring the voltage of the buffer store 16 in step S202.

In real use, the duration of the charging pause can depend on the solar radiation. On days with little sun, the solar module 14 only supplies little power, which leads to the buffer store 16 charging very slowly, depending on the ratio of the size of the solar module 14 to capacitance of the buffer store 16, for example a capacitor.

Therefore, charging pauses of up to several minutes are also conceivable or even an entire night. On sunny days, the capacitor 16 can be charged significantly faster than 15 seconds. In this case, the control unit 20 must prevent the switching element 24 from switching through prematurely.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE DESIGNATIONS

10 vehicle
12 energy source
14 solar module
16 buffer store
20 control unit
22 pulse generator
24 switching element
30 diode
32 diode
34 resistor
36 fuse
40 battery
50 current pulse
52 time duration
54 time interval
60 time
61 current
62 on
64 off
70 jump start cable support point
100 device

1-11. (canceled)

12. A method for trickle charging a battery of a vehicle, the method comprising:
determining, by a control unit, voltages of the battery and of an energy source, wherein the control unit is electrically coupled to the energy source and the battery;
determining, when the voltage of the battery is less than the voltage of the energy source, whether a control pulse has been applied to the control unit;
switching, by the control unit and responsive to the determination that the control pulse has been applied to the control unit, a switching element so that a current pulse is provided to the battery;
determining whether the control pulse is switched off; and
blocking the switching element responsive to the determination that the control pulse is switched off, blocking the switching element,
wherein current pulses are provided to the battery in a specifiable interval of time until the voltage of the battery is at least equal to the voltage of the energy source,
wherein a time duration of the current pulse and an interval of time between the current pulses are selected such that an onboard power supply of the vehicle remains in a passive mode, and
wherein the current pulses are selected to be so short and to occur with such a large interval of time that a fault suppression of the onboard power supply classifies these current pulses as not relevant and the vehicle with electrical consumers in the onboard power supply is not activated.

13. The method of claim 12, wherein the time duration of the current pulse and the interval of time between the current pulses are
set manually according to specifiable parameters,
determined from a characteristic map of the vehicle, or
determined by measurements on the battery or the energy source.

14. The method of claim 12, wherein the energy source is a solar module, and wherein electrical energy produced by the solar module is buffer-stored in an electrical buffer store.

15. The method of claim 14, further comprising:
determining, by the control unit, a voltage of the electrical buffer store, wherein the control unit is electrically coupled to the electrical buffer store;
determining that the voltage of the electrical buffer store is greater than the voltage of the battery and checking whether it is possible or permissible to provide the current pulse;
switching, by the control unit and when it is possible or permissible to provide the current pulse, the switching element so that the current pulse is provided to the battery;
determining whether an end of the time duration of the current pulse has been reached; and
blocking the switching element when it is determined that the end of the time duration of the current pulse has been reached.

16. A device for trickle charging a battery of a vehicle, the device comprising:
an energy source electrically coupled to the battery via a control unit during normal operation; and
a control unit configured to provide current pulses from the energy source with a specifiable time duration in a specifiable interval of time to the battery, wherein the control unit comprises a pulse generator or is electrically coupled to a pulse generator,
wherein the pulse generator is configured to generate the current pulses with a time duration and time interval selected such that an onboard power supply of the vehicle remains in a passive mode,
wherein the current pulses are selected to be so short and to occur at such a large interval of time that a fault suppression of the onboard power supply classifies these current pulses as not relevant and the vehicle with electrical consumers in the onboard power supply is not activated.

17. The device of claim 16, wherein the energy source is a solar module with an electrical buffer store, wherein the electrical buffer store is configured to buffer-storing electrical energy of the solar module produced in the solar module.

18. The device of claim 17, wherein the electrical buffer store is a supercapacitor.

19. The device of claim 16, wherein the control unit is configured to provide the current pulses to the battery by triggering a switching element.

20. The device of claim 16, wherein the energy source is electrically coupled to the vehicle via at least one electrical fuse.

21. The device of claim 16, wherein the energy source is electrically coupled to the vehicle via a jump start cable support point.
